(19) United States
(12) Patent Application Publication
(10) Pub. No.: US 2005/0141901 A1
(43) Pub. Date: Jun. 30, 2005

(54) Method and apparatus to prevent filling of non-identification toner

(76) Inventor: Sang-jin Lee, Suwon-si (KR)

Correspondence Address: STANZIONE & KIM, LLP, 1740 N STREET, N.W., FIRST FLOOR, WASHINGTON, DC, 20036, US

(21) Appl. No.: 11/020,141

(22) Filed: Dec. 27, 2004

(30) Foreign Application Priority Data
Dec. 27, 2003 (KR) 2003-98233

(51) Int. Cl. G03G 15/00; G03G 15/08

(52) U.S. Cl. 399/12; 399/27

(57) ABSTRACT

A method and apparatus of preventing filling of a non-identification toner. The method includes sensing an update request of remaining amount information of a toner in a toner cartridge to be refilled with the toner using the refill toner kit, and confirming a refill identifier of the refill toner kit and updating the information of the remaining amount of the toner. When refilling the toner cartridge with the toner, if a non-authenticated toner is loaded in the toner cartridge, the remaining toner information of the toner is not updated, thereby preventing a part of the printer from being damaged, allowing only authenticated toners to be introduced in the market, securing the reliability of the toner products, and preventing conflicts of interest of an authenticated toner manufacturer with a non-authenticated toner manufacturer.

### CROSS-REFERENCE TO RELATED APPLICATIONS

This application claims the priority of Korean Patent Application No. 2003-98233, filed on Dec. 27, 2003, in the Korean Intellectual Property Office, the disclosure of which is incorporated herein in its entirety by reference.

### BACKGROUND OF THE INVENTION

1. Field of the Invention

The present general inventive concept relates to a printer, and more particularly, to a method and apparatus to prevent a non-identification toner from being filled during a toner filling process.

2. Description of the Related Art

In a printer, toner is continuously supplied while a printing is performed. In a conventional printer, when the toner received in a toner cartridge is all consumed, the toner cartridge is replaced by a new one for a new printing.

In a conventional method of replacing the toner cartridge, a user is forced to use a disposable toner cartridge, which causes a problem of excessive toner consumption. To this end, a toner filling method is preferred instead of the conventional cartridge replacing method. However, the toner filling method may cause a drawback of a refill of a non-identification toner. When the non-identification toner having a low quality is refilled, it may cause disorder of the printer. Also, the distribution of the non-identification toner causes conflicts of the interest of an identification toner provider and affects healthy distribution of an identification toner.

### SUMMARY OF THE INVENTION

The present general inventive concept provides a method of preventing a refill of a non-identification toner in which a remaining amount information of a toner can be updated only by a refill of an identification toner.

The present general inventive concept also provides an apparatus to prevent a refill of a non-identification toner so that a remaining amount information of a toner can be updated only by a refill of an identification toner.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of preventing a refill of a non-identification toner, the method comprising sensing an update request of a remaining amount information of a toner in a toner cartridge in which the toner is refilled using a refill toner kit, and confirming a refill identifier of the refill toner kit and updating the information of the remaining amount of the toner.

The foregoing and/or other aspects and advantages of the present general inventive concept may also be achieved by providing an apparatus to prevent a refill of a non-authentication toner, the apparatus comprising a remaining amount information update request-sensing part which senses an update request of information about an amount of a remaining toner of the toner in a toner cartridge to be refilled with a new toner using a refill toner kit, and outputs the sensing result as a sensing signal, and a remaining amount information-updating controller which confirms a refill identifier of the refill toner kit and updates the information of the remaining amount of the toner.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart of a method of preventing a refill of a non-identification toner according to an embodiment of the present general inventive concept;

FIG. 2 is a flowchart of operation 12 of the method shown in FIG. 1;

FIG. 3 is a flowchart of operation 32 of the method shown in FIG. 2;

FIG. 4 is a flowchart of operation 36 of the method shown in FIG. 2;

FIG. 5 is a block diagram of an apparatus to prevent a refill of a non-identification toner according to another embodiment of the present general inventive concept;

FIG. 6 is a block diagram of a remaining amount information-updating controller in the apparatus of FIG. 5;

FIG. 7 is a block diagram of a valid input number checking part shown in FIG. 6; and

FIG. 8 is a block diagram of an identification (authentication) checking part shown in FIG. 6.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

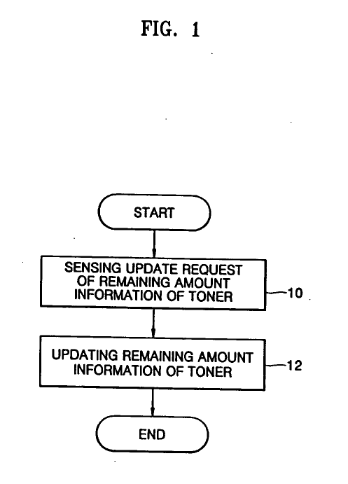

FIG. 1 is a flowchart of a method of preventing a refill of a non-identification toner according to an embodiment of the present general inventive concept. The method of FIG. 1 includes operations 10 and 12 of updating information about an amount of a remaining toner by an update instruction of the remaining toner information.

First, in the operation 10, an update request regarding a remaining toner information of a toner cartridge to be refilled with a toner using a refill toner kit, is detected. The refill toner kit is a toner container having a new toner used to refill the toner cartridge, and has a construction suitable for refilling the toner cartridge with the new toner. The remaining toner information is to inform how much toner remains in the toner cartridge. In other words, it is detected that an update regarding the remaining toner information is requested by a user.

Then, in the operation 12, a refill identifier of the refill toner kit is checked and the remaining toner information is updated. The refill identifier is an inherent identification number provided to each refill toner kit. When the refill identification of the refill toner kit corresponds to an authenticated number, the toner refilled in the toner cartridge is an authenticated toner and accordingly the remaining toner information is updated to reveal that the toner is refilled in the toner cartridge.

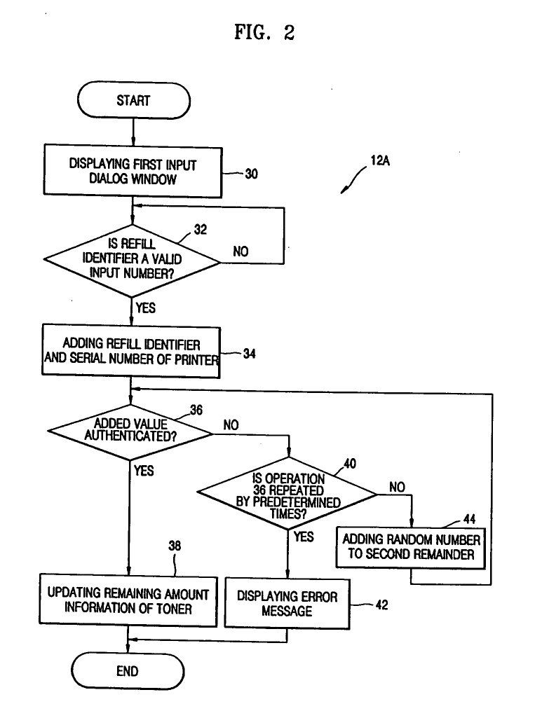

FIG. 2 is a flowchart of a detecting operation 12 (12A) of an update request in the method shown in FIG. 1. The detecting operation 12A includes updating the remaining toner information or displaying an error message with an authentication result when the toner refilled in the toner cartridge is not authenticated, depending on a determination of whether an input identification number is authenticated. (operations 30 through 34).

First, a first input dialog window for an input of the refill identifier is displayed (operation 30). In order to display the first input dialog window, a printer (image forming apparatus) may be provided with a display such as a liquid crystal display (LCD) or the like. The display may be connected to the image forming apparatus through a cable.

Then, it is determined whether or not the refill identifier inputted by a user through the first input dialog window is a valid input number (operation 32). The valid input number is a number in accordance with a combination of numbers commonly used in an authenticated refill identifier. When the refill identifier inputted by the user is a valid input number in operation 32, the operation 34 is performed. However, when the input refill identifier is not a valid input number, the operation 32 is performed. In other words, a new refill identifier is again inputted and then it is determined whether or not the newly inputted refill identifier is the valid input number. The refill identifier may be input through the display and may be automatically scanned from the refill toner kit using a scanner (not shown) provided in the printer to scan a code corresponding to the refill identifier.

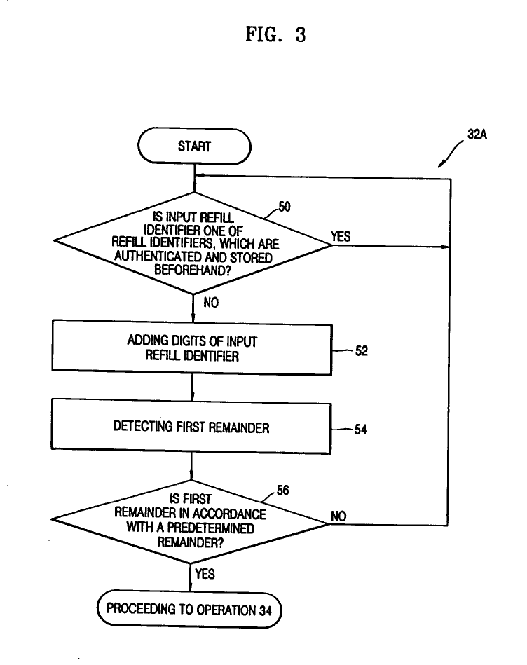

FIG. 3 is a flowchart of the operation 32 (32A) of the method shown in FIG. 2. The operation 32A includes detecting a first remainder value obtained by adding respective digits of the input refill identifier, and determining whether or not the detected first remainder value is identical to a predetermined remainder value. (operations 50 through 56).

First, it is determined whether or not the input refill identifier is identical to one of refill identification numbers which were authenticated and stored. (operation 50) This operation 50 is to prevent a prior authenticated refill identifier from being re-inputted and re-authenticated as a new refill identifier for the update of the remaining toner information. The prior authenticated refill identifiers are stored in the printer. If the input refill identifier is identical to one of the prior authenticated refill identifiers, the input refill identifier is determined to be re-inputted after being authenticated, and the operation 42 is performed to display an error message so that the remaining toner information cannot be updated.

However, if the input refill identifier is not identical to one of the prior authenticated refill identifiers, respective digits of the input refill identifier are added (operation 52). If the input refill identifier is not identical to one of the prior authenticated refill identifier, the input refill identifier is not regarded as an input of the prior authenticated refill identifier which was used to refill. Accordingly, the respective digits of the input refill identifier are added. For example, assuming that the input refill identifier is ‘123456789,’ a sum of all digits of the input refill identifier is ‘1+2+3+4+5+6+7+8+9=45.’

After the operation 52, the added value is divided by a first divisor and a first remainder is obtained (operation 54). The first divisor is a preset value and may be arbitrarily set. For instance, assuming that a sum is ‘45’ and a first divisor is ‘4,’ if the sum ‘45’ is divided by the first divisor ‘4,’ a quotient of ‘11’ and a remainder of ‘1’ are obtained. In other words, ‘1’ corresponding to the first remainder value is detected. Also, assuming that the sum is ‘45’ and the first divisor is ‘5,’ if the sum ‘45’ is divided by a divisor of ‘5,’ a quotient of ‘9’ and the first remainder of ‘0’ are obtained. In other words, ‘0’ corresponding to the first remainder value is detected.

After the operation 54, it is determined whether the first remainder value is identical a predetermined remainder (operation 56). The predetermined remainder is a preset value or may be an arbitrary value. For example, when assuming that a sum of all digits of an input refill identifier is ‘45,’ a first divisor is ‘4,’ and the predetermined remainder is ‘1,’ since the first remainder is identical to the predetermined remainder, the input refill identifier is determined to be valid, and accordingly the operation 34 is performed. However, if the predetermined remainder is not ‘1,’ since the first remainder is not identical to the predetermined remainder, the input refill identifier is determined to be invalid, and accordingly the operation 50 is performed. Also, when assuming that a sum of all digits of the input refill identifier is ‘45,’ the first divisor is ‘5,’ and the predetermined remainder is ‘0,’ since the first remainder is identical to the predetermined remainder, the input refill identifier is determined to be valid, and accordingly the operation 34 is performed. However, if the predetermined remainder is not ‘0,’ since the first remainder is not identical to the predetermined remainder, the input refill identifier is determined to be invalid, and accordingly the operation 50 is performed.

Meanwhile, in the operation 32 of FIG. 2, when the input refill identifier is determined to be valid, the input refill identifier is added to a printer serial number of the printer. (operation 34) The printer serial number represents an identification number assigned to a product of a model by a printer manufacturer. For example, when a serial number of a printer is ‘5698741’ and an input refill identifier is ‘123456789,’ the two values are added and a value of ‘129155530’ is obtained.

The operation 32 and the operation 34 may be omitted if necessary. Hence, the operation 36 may be performed after the operation 30, may be performed after the operation 32 by omitting the operation 34, or may be performed after the operation 34 by omitting the operation 32.

After the operation 30 or operation 32, it is determined whether the input refill identifier is authenticated, or after the operation 34, it is determined whether a sum of the input refill identifier and the serial number of the printer of a model is authenticated. (operation 36).

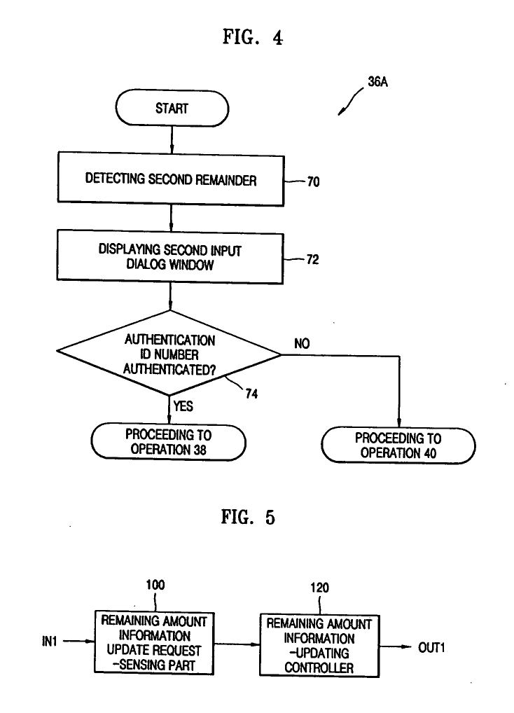

FIG. 4 is a flowchart of operation 36 (36A) of the method shown in FIG. 2, and the operation 23A includes operations 70 through 74 of determining whether an authentication ID number inputted through a second input dialog window is authenticated.

After the operation 30 or operation 32, the input refill identifier is divided by a second divisor, and a second remainder obtained by dividing the input refill identifier by the second divisor is detected. After the operation 34, a sum of the input refill identifier and the serial number of the printer may be divided by the second divisor, and the second remainder obtained by dividing the sum by the second divisor can be detected (operation 70). The refill toner kit can be provided with an authentication card. The authentication card may include predetermined numbers corresponding to authentication confirmation information including the second remainder and an authentication ID (authentication confirmation) number corresponding to the second remainder. In other words, the authentication card is a card used to authenticate use of the refill toner, like a security card used in Internet banking. Each predetermined number of the authentication confirmation information of the authentication card is designated as a value of the second divisor. By dividing the refill identifier or the sum of the refill identifier and the serial number of the printer by the value of the second devisor corresponding to the predetermined number of the authentication confirmation information, values of the second remainder corresponding to a digit of the second divisor are obtained. The authentication card has authentication ID numbers corresponding to the values of the second remainder by the digit of the second devisor.

As an example of the authentication card T, table 1 is provided below.

TABLE 1

| Second | Authentication | Second | Authentication |
|---|---|---|---|
| remainder | confirmation No. | remainder | confirmation No. |
| 0 | 1234 | 10 | 0159 |
| 1 | 2345 | 11 | 0357 |
| 2 | 3456 | 12 | 8520 |
| 3 | 4567 | 13 | 4560 |
| 4 | 5678 | 14 | 3698 |
| 5 | 6789 | 15 | 7896 |
| 6 | 7890 | 16 | 7412 |
| 7 | 8901 | 17 | 5231 |
| 8 | 9012 | 18 | 3251 |
| 9 | 0123 | 19 | 1254 |

As shown in table 1, the authentication confirmation information includes twenty different sets of numbers as an example. That is, the authentication confirmation information may include twenty values of the second remainder and twenty authentication ID numbers corresponding to the respective values of the second remainder. The twenty values of the second remainder are kinds of values obtained by dividing the refill identifier or the sum of the refill identifier and the serial number of the printer by a divisor of 20. In other words, the digit ‘20’ functions as the second divisor to divide the refill identifier or the sum of the refill identifier and the serial number of the printer.

In a case of the authentication card mentioned above, the identical authentication card is assigned to an identical model of printers. Also, the authentication confirmation information of a reference authentication card is stored in the printer. The stored authentication confirmation information is used as reference data to determine whether a newly inputted refill identifier is an authenticated number.

For instance, when the sum of the refill identifier and the serial number of the printer is ‘129155530’ and the second devisor is ‘20,’ the 129155530 is divided by the second devisor of 20, and accordingly a quotient of ‘6457776’ and a remainder of ‘10’ are obtained. In other words, the second remainder is ‘10.’

After the operation 70, the second input dialog window through which an authentication ID number corresponding to the detected second remainder is input is displayed (operation 72). The second input dialog window is a dialog window which is displayed such that the user can input the authentication confirmation number (authentication ID number) corresponding to the second remainder included in the authentication confirmation information of the authentication card. To display the second input dialog window, the printer may be provided with a display such as an LCD screen.

After the operation 72, it is determined whether the authentication ID number input through the second input dialog window by the user is authenticated. The user inputs the authentication ID number corresponding to the second remainder included in the authentication confirmation information of the authentication card. Thus, by determining whether the authentication ID number inputted by the user is identical to the authentication ID number of the reference authentication card which has been stored in the printer, it is determined whether the authentication ID number inputted through the second input dialog window by the user is authenticated. For instance, when the second remainder detected in the operation 70 is ‘10’ and the authentication card has the above table 1, the user can input the authentication ID number of ‘0159’ corresponding to the second remainder of ‘10’ through the second input dialog window. The authentication ID number of ‘0159’ inputted by the user is compared with the authentication ID number of the reference authentication card stored in the printer. When the authentication ID number of ‘0159’ input by the user is identical to the authentication ID number of the reference authentication card which has been stored in the printer, the input authentication ID number is determined to be authenticated.

When the authentication ID number inputted through the second input dialog window is authenticated, the operation 38 is performed, while when the authentication ID number inputted through the second input dialog window is not authenticated, the operation 40 is performed.

In the operation 36, when the input refill identifier is authenticated, or the sum of the input refill identifier and the serial number of the printer is authenticated, the information on an amount of the remaining toner is updated such that a new amount of toner refilled in the toner cartridge is displayed (operation 38). Once the authentication of the refill identifier is confirmed, the information on the amount of the remaining toner is automatically updated.

When the information on the amount of the remaining toner is updated, the printer becomes a state that a printing process can be performed.

Meanwhile, in the operation 36, when the input refill identifier is not authenticated, or the sum of the input refill identifier and the serial number of the printer is not authenticated, it is determined whether the operation 36 is repeated predetermined times (operation 40).

If it is determined that the operation 36 is repeated more than the predetermined times, an error message that the toner of the refill toner kit is not an authenticated toner is displayed (operation 42). If the refill toner is not authenticated in spite that the operation 36 is repeated the predetermined times, it is determined that the refill identifier of the refill toner kit is not authenticated. Since information on the remaining amount of the non-authenticated toner and the refilled toner is not updated, an error message that the printing process cannot be performed is displayed.

Ultimately, since the information on the remaining amount of the non-authenticated and the refilled toner is not updated, and accordingly the printing process cannot be performed, the non-authenticated toner can be prevented from being refilled.

Meanwhile, if the operation 36 is not repeated the predetermined times, a random number is added to the second remainder and the operation 36 is performed (operation 44). The random number is a number selected arbitrarily. The operation 36 is repeated predetermined times until the authentication ID number is authenticated using the sum of the random number and the second remainder as a new second remainder. For instance, when assuming that the second remainder is ‘10,’ the input authentication ID number is ‘0159’ and the random number is ‘4,’ if the input authentication number is not authenticated, the random number of ‘4’ is added to the 10 corresponding to the second remainder. In the operation 36, the sum of ‘14’ is detected as a new value of the second remainder.

The operations 40 and 42 may be omitted. Hence, in the operation 36, when the input refill identifier or the sum of the refill identifier and the serial number of the printer is not authenticated, the operation 42 is performed.

Next, an apparatus to prevent a refill of a non-authenticated toner according to another embodiment of the present general inventive concept will now be described with reference to the accompanying drawings.

FIG. 5 is a block diagram of an apparatus to prevent a refill of a non-identification toner according to another embodiment of the present general inventive concept.

Referring to FIG. 5, the apparatus includes a remaining amount information update request-sensing part 100 and a remaining amount information-updating controller 120.

The remaining amount information update request-sensing part 100 senses whether an update of information about a remaining toner of a toner cartridge (not shown) filled with a refill toner of a refill toner kit is requested through an input terminal INI, and outputs a sensed result as a sensing signal to the remaining amount information-updating controller 120.

The remaining amount information-updating controller 120 confirms a toner identifier of the refill toner kit in response to the sensing signal inputted by the remaining amount information update request-sensing part 100, and outputs a control signal to control the update of the remaining toner information through an output terminal OUT1.

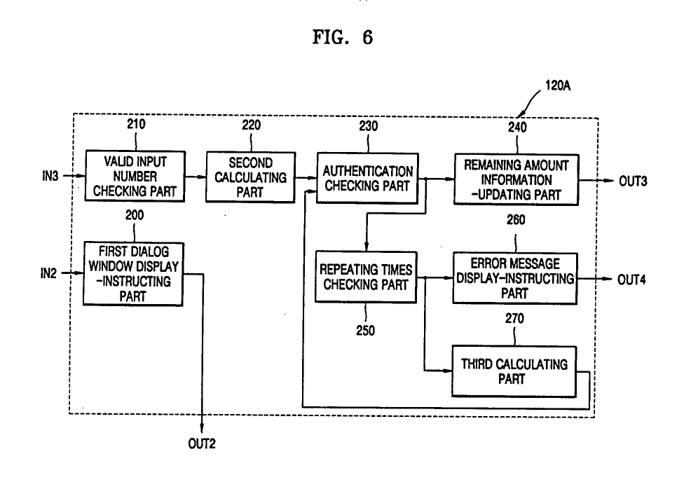

FIG. 6 is a block diagram of the remaining amount information-updating controller 120 (120A) shown in the apparatus of FIG. 5. Referring to FIGS. 5 and 6, the controller 120A includes a first dialog window display-instructing part 200, a valid input checking part 210, a second calculating part 220, an authentication checking part 230, a remaining amount information-updating part 240, a repeating times checking part 250, an error message display-instructing part 260, and a third calculating part 270.

The first dialog window display-instructing part 200 controls a display part (not shown) to display a first input dialog window. In other words, in response to the sensing signal inputted through an input terminal IN2 from the remaining amount information update request-sensing part 100, the first dialog window display-instructing part 200 controls the display part to display the first dialog window, and outputs an instruction result as a display instruction signal to the display part of the printer through an output terminal OUT2. The display part displays the first input dialog window in response to the instruction signal of the first dialog window display-instructing part 200. The display part may be an LCD screen.

The valid input checking part 210 checks whether the refill identifier input through the first dialog window by the user is valid, and outputs checked results as a second checking signal. In other words, the valid input checking part 210 receives the refill identifier from the first dialog window input by the user through an input terminal IN3, checks whether the input refill identifier corresponds to a number in accordance with a numbering rule to identify the refill identifier, and outputs the checked results as the second checking signal to the second calculating part 220.

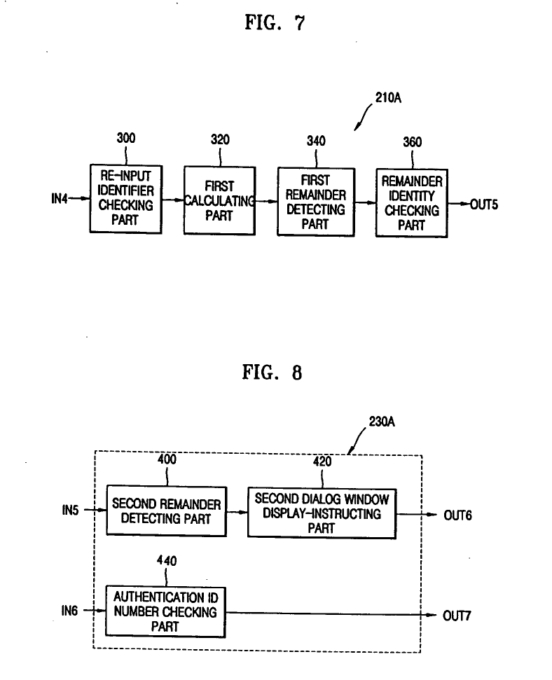

FIG. 7 is a block diagram of the valid input number checking part 210 (210A) shown in FIG. 6. The valid input number checking part 210A includes a re-input identifier checking part 300, a first calculating part 320, a first remainder detecting part 340 and a remainder identity checking part 360.

Referring to FIGS. 6 and 7, the re-input identifier checking part 300 checks whether the refill identifier input from the user through an input terminal IN4 is identical to one of reference refill identifiers previously authenticated and stored in a storage space of the printer, and outputs a third checking signal representing the check result to the first calculating part 320. In other words, the re-input identifier checking part 300 checks whether the input refill identifier is identical to the reference refill identifier authenticated and stored in the storage space of the printer so as to prevent the refill identifier authenticated and stored in the storage space of the printer from being repeatedly inputted and authenticated, that is, so as to prevent the refill identifier from being re-inputted.

The first calculating part 320 adds all digits of the input refill identifier in response to the third checking signal input from the re-input identifier checking part 300. Then, the first calculating part 320 outputs the adding result as a first adding signal to the first remainder detecting part 340.

The first remainder detecting part 340 divides a sum of the all digits of the input refill identifier by a predetermined first divisor in response to the first adding signal input from the first calculating part 320. Then, the remainder detecting part 340 detects a first remainder corresponding to a remainder obtained by dividing the sum by the first divisor. The first remainder detecting part 340 outputs a first detecting signal representing the detection result to the remainder identity checking part 360.

The remainder identity checking part 360 checks whether the first remainder is identical to a predetermined reference remainder in response to the first detecting signal input from the first remainder detecting part 340. Then, the remainder identity checking part 360 outputs a fourth checking signal corresponding to the check result to the second calculating part 220 through an output terminal OUT5. The fourth checking signal represents that the first remainder is identical to the predetermined reference remainder previously determined and stored in the printer.

The second calculating part 220 adds the refill identifier input through the first input dialog window and a printer serial number corresponding to an ID number of the printer in response to the second checking signal input from the valid input number checking part 210. Then, the second calculating part 220 outputs the adding result as a second adding signal to the authentication checking part 230.

The authentication checking part 230 checks whether a sum of the refill identifier and the printer serial number is authenticated. Then, the authentication checking part 230 outputs a first checking signal corresponding to the check result to the remaining amount information-updating part 240 and the repeating times checking part 250. In addition, the authentication checking part 230 may check whether the refill identifier input through the first input dialog window is authenticated, and then output the first checking signal corresponding to the check result to the remaining amount information-updating part 240 and the repeating times checking part 250.

Meanwhile, the authentication checking part 230 checks whether a third adding signal inputted from a third calculating part 270 is authenticated in response to the input third adding signal. Then, the authentication checking part 230 outputs the first checking signal corresponding to the check result to the remaining amount information-updating part 240 and the repeating times checking part 250.

FIG. 8 is a block diagram of the authentication checking part 230 (230A) of FIG. 6. The authentication checking part 230A includes a second remainder detecting part 400, a second dialog window display-instructing part 420 and an authentication ID number checking part 440.

Referring to FIGS. 6 through 8, the second remainder detecting part 400 divides the sum of the refill identifier input from the second calculating part 220 and the printer serial number, input through an input terminal IN5, using a predetermined second divisor. Then, the second remainder detecting part 400 detects a second remainder corresponding to a remainder obtained by dividing the sum by the second divisor, and outputs a detecting result as a second detecting signal to the second dialog window display-instructing part 420. In addition, the second remainder detecting part 400 may divide the refill identifier, input from the first input dialog window through the input terminal IN5, by the second divisor, and then may detect the second remainder corresponding to the remainder obtained by dividing the refill identifier by the second divisor. Then, the second remainder detecting part 400 outputs the detecting result as the second detecting signal to the second dialog window display-instructing part 420.

Meanwhile, the second remainder detecting part 400 may detect the third adding signal as the second remainder in response to the third adding signal input from the third calculating part 270. Then, the second remainder detecting part 400 may output the second detecting signal corresponding to the detection result to the second dialog window display-instructing part 420.

The second dialog window display-instructing part 420 generates an instruction to the display part (not shown) to display a second input dialog window through which a user inputs the number representing the authentication ID number corresponding to the detected second remainder in response to the second detecting signal input from the second remainder detecting part 400. Then, the second dialog window display-instructing part 420 outputs a second input dialog window display instruction signal corresponding to the instruction result to the display part through an output terminal OUT6. The display part (not shown) displays the second input dialog window according to the second input dialog window display instruction signal.

When the user inputs an authentication ID number to the second input dialog window, the authentication ID number checking part 440 receives the authentication ID number through an input terminal IN6. Then, the authentication ID number checking part 440 checks whether the authentication ID number is authenticated by checking whether the authentication ID number is identical to a predetermined reference authentication ID number of a reference authentication card stored in a predetermined storage space of the printer. Then, the authentication ID number checking part 440 outputs a fifth checking signal for the input refill identifier corresponding to the check result to the remaining amount information-updating part 240 and the repeating times checking part 250 through an output terminal OUT7.

The remaining amount information-updating part 240 generates an instruction to update the information on the amount of the remaining toner in response to the first checking signal so that the information indicates that the toner cartridge needs to be refilled with a new toner. The remaining amount information-updating part 240 receives the first checking signal representing that the refill identifier or the sum of the refill identifier and the printer serial number is authenticated from the authentication checking part 230. In other words, the remaining amount information-updating part 240 generates the instruction to update the information on the remaining amount of the toner in response to the input first checking signal, and then outputs a remaining amount information updating signal corresponding to the instruction result, to the output terminal OUT3. The information on the remaining amount of the toner is automatically updated by the remaining amount information updating signal.

The repeating times checking part 250 checks whether an operation of the authentication checking part 230 is repeated predetermined times in response to the first checking signal, and then outputs the checking result as a sixth checking signal to the error message display-instructing part 260 and the third calculating part 270. In other words, the repeating times checking part 250 receives the first checking signal representing that the refill identifier or the sum of the refill identifier and the printer serial number is not authenticated from the authentication checking part 230. The repeating times checking part 250 checks whether the authentication checking part 230 repeats its operation predetermined times by counting the output number of the checking signals for authentication of the authentication checking part 230 in response to the received first checking signal. Then, the repeating times checking part 250 outputs the checking result as the sixth checking signal to the error message display-instructing part 260 and the third calculating part 270. The first checking signal of the authentication checking part 230 may be transmitted directly to the error display instruction part 260 if the repeating times checking part 250 is omitted.

The error display instruction part 260 generates an instruction to display an error message representing that the toner to refill the toner cartridge using the refill toner kit is not authenticated toner in response to the sixth checking signal input from the repeating times checking part 250, and then outputs the instruction result to an output terminal OUT4.

Meanwhile, the error display instruction part 260 generates the instruction to display the error message in response to the first checking signal input from the authentication checking part 230, and then outputs the instruction result to an output terminal OUT4.

The third calculating part 270 adds the second remainder detected by the second remainder detecting part 400 of the authentication checking part 230 and a random number in response to the sixth checking signal input from the repeating times checking part 250. Then, the third calculating part 270 outputs the adding result as the third adding signal to the authentication checking part 230.

As described above, when a non-authenticated toner is used to refill the toner cartridge, the non-authentication toner refill protection method and apparatus prevents the information on the remaining amount of the toner from being updated so that the printer is prevented from being damaged. In addition, since only authenticated toners are allowed to be introduced in the market, the reliability of the products is guaranteed, and the conflicts of the interests of the authenticated toner producers with the non-authenticated toner producers are reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of preventing refill of a non-authentication toner in a printer having a toner cartridge to be refilled with a toner using a refill toner kit, the method comprising:
sensing an update request of information about a remaining amount of a toner in a toner cartridge to be refilled with the toner using a refill toner kit; and
confirming a refill identifier of the refill toner kit and updating the information of the remaining amount of the toner according to the confirmation of the refill identifier.

2. The method of claim 1, wherein the updating of the information of the remaining amount of the toner comprises:
displaying a first input dialog window through which the refill identifier is input;
determining whether the refill identifier input through the first input dialog window is authenticated;
when the input refill identifier is authenticated, updating the information of the remaining amount of the toner of the toner cartridge; and
when the input refill identifier is not authenticated, displaying an error message that the toner to refill the toner cartridge using the refill toner kit is not an authenticated toner.

3. The method of claim 2, wherein the updating of the information of the remaining amount of the toner further comprises after the displaying of the first input dialog window, determining whether the refill identifier input through the first input dialog window corresponds to a valid input number,
wherein, if the refill identifier input through the first input dialog window corresponds to the valid input number, determining whether the refill identifier input through the first input dialog window is authenticated, and if the refill identifier input through the first input dialog window does not correspond to the valid input number, determining whether the refill identifier input through the first input dialog window corresponds to the valid input number after the displaying of the first input dialog window.

4. The method of claim 3, wherein the determining of whether the refill identifier inputted through the first input dialog window corresponds to the valid input number, comprises:
determining whether the input refill identifier is identical to one of reference refill identifiers that have been authenticated and stored in the printer;
when the input refill identifier is not identical to one of the reference refill identifiers, adding digits of the input refill identifier;
dividing the added value by a first divisor to detect a remainder as a first remainder; and
determining whether the first remainder is identical to a predetermined remainder,
wherein the input refill identifier is recognized to be the valid input number when the first remainder is identical to the predetermined remainder.

5. The method of claim 2, wherein the updating of the information of the remaining amount of the toner further comprises adding the input refill identifier to a serial number of the printer after the displaying of the first input dialog window, and determining whether the refill identifier input through the first input dialog window is authenticated.

6. The method of claim 2, wherein the determining of whether the refill identifier input through the first input dialog window is authenticated, comprises:
dividing the input refill identifier by a second devisor to detect a reminder as a second remainder;
displaying a second input dialog window through which an authentication ID number corresponding to the detected second remainder is input; and
determining whether the authentication ID number input through the second input dialog window is authenticated,
wherein updating the information of the remaining amount of the toner of the toner cartridge if the authentication ID number input through the second input dialog window is authenticated, and displaying the error message if the authentication ID number input through the second input dialog window is not authenticated.

7. The method of claim 6, wherein the determining of whether the refill identifier input through the first input dialog window is authenticated comprises:
providing the refill toner kit with an authentication card having authentication confirmation information including the second remainder and the authentication ID number corresponding to the second remainder.

8. The method of claim 7, wherein the determining of whether the refill identifier input through the first input dialog window is authenticated comprises:
providing the printer of an identical model with a reference identical authentication card.

9. The method of claim 8, wherein the determining of whether the refill identifier input through the first input dialog window is authenticated comprises:
storing reference authentication confirmation information in the printer to compare the refill identifier with the reference authentication confirmation to determine whether the refill identifier is authenticated.

10. The method of claim 6, wherein the confirming of the refill identifier of the refill toner kit and the updating of the information of the remaining amount of the toner according to the confirmation of the refill identifier comprise:
determining whether the determining operation of whether the refill identifier input through the first input dialog window is authenticated is repeated predetermined times if the refill identifier is not authenticated; and
adding a random number to the second remainder to perform the determining operation if the determining operation is not repeated the predetermined times,
wherein the error message is displayed if the determining operation is repeated the predetermined times.

11. The method of claim 1, wherein the confirming of the refill identifier of the refill toner kit comprises:
determining whether the refill identifier is a valid number.

12. The method of claim 1, wherein the confirming of the refill identifier of the refill toner kit comprises:
determining whether the refill identifier is identical to a reference refill identifier stored in the printer.

13. The method of claim 1, wherein the refill identifier comprises a number having a plurality of digits, and the confirming of the refill identifier of the refill toner kit comprises:
adding the digits of the number of the refill identifier; and
determining whether a value corresponding to the added digits is identical to a reference value.

14. The method of claim 1, wherein the confirming of the refill identifier of the refill toner kit comprises:
detecting a remainder corresponding to the refill identifier; and
determining whether the reminder is identical to a reference value.

15. The method of claim 1, wherein the refill identifier comprises an authentication ID number, and the confirming of the refill identifier of the refill toner kit comprises:
determining whether the authentication ID number is identical to a reference number.

16. The method of claim 1, wherein the printer comprises a serial number, and the confirming of the refill identifier of the refill toner kit comprises:
adding the refill identifier and the serial number; and
determining whether the added value is identical to a reference value.

17. The method of claim 16, wherein the confirming of the refill identifier of the refill toner kit comprises:
detecting a remainder corresponding to the added value; and
determining whether the reminder is identical to a reference value.

18. The method of claim 1, wherein the confirming of the refill identifier of the refill toner kit comprises:
determining whether a characteristic representing the refill identifier of the refill toner kit is identical to one of reference values, to confirm the refill identifier of the refill toner kit.

19. The method of claim 1, wherein:
the refill toner kit comprises an authentication card having data corresponding to the refill identifier;
the printer comprises a reference authentication card having reference data; and
the confirming of the refill identifier of the refill toner kit comprises determining whether the data of the authentication card represents the reference data of the reference authentication card, to confirm the refill identifier of the refill toner kit.

20. The method of claim 1, further comprising:
displaying a window when the update request is sensed; and
generating data representing the refill identifier of the refill toner kit through the window so that the refill identifier of the refill toner kit is confirmed according to the data.

21. The method of claim 1, further comprising:
generating a message signal representing that at least one of the toner and the refill toner kit is not acuthenticated, when the refill identifier is not confirmed.

22. An apparatus to prevent a refill of a non-authentication toner in a printer having a toner cartridge to be refilled with toner using a refill toner kit, the apparatus comprising:
a remaining amount information update request-sensing part which senses an update request of information about a remaining amount of a toner in a toner cartridge to be refilled with the toner using a refill toner kit, and outputs the sensing result as a sensing signal; and
a remaining amount information-updating controller which confirms a refill identifier of the refill toner kit and updates the information of the remaining amount of the toner according to the confirmation of the refill identifier of the refill toner kit.

23. The apparatus of claim 22, wherein the remaining amount information-updating controller comprises:
a first dialog window display-instructing part which instructs to display a first input dialog window through which the refill identifier is input;
an authentication checking part which checks whether the refill identifier input through the first input dialog window is authenticated, and outputs the checking result as a first checking signal;
a remaining amount information-updating part which instructs to update the information of the remaining amount of the toner of the toner cartridge in response to the first checking signal; and
an error message display-instructing part which instructs to display an error message that the toner to refill the toner cartridge using the refill toner kit is not an authenticated toner, in response to the first checking signal.

24. The apparatus of claim 23, wherein the remaining amount information-updating controller further comprises;
a valid input number checking part which checks whether the refill identifier input through the first dialog window is valid, and outputs the checking result as a second checking signal to the authentication checking part.

25. The apparatus of claim 24, wherein the valid input checking part comprises:
a re-input identifier checking part which checks whether the input refill identifier is identical to one of reference refill identifiers that have been authenticated and stored in the printer, and outputs the checking result as a third checking signal;
a first calculating part which adds digits of the input refill identifier and outputs an added value of the digits as a first adding signal;
a first remainder detecting part which divides the added value by a first divisor, detects a remainder obtained by dividing the added value by the first divisor, as a first reminder; and outputs the detecting result as a first detecting signal, in response to the first adding signal; and
a remainder identity checking part which checks whether the first remainder is identical to a predetermined remainder and outputs the checking result as a fourth checking signal, in response to the first detecting signal.

26. The apparatus of claim 23, wherein the remaining amount information-updating controller further comprises:
a second calculating part which adds the input refill identifier to a serial number of the printer and outputs the adding result as a second adding signal to the authentication checking part.

27. The apparatus of claim 23, wherein the authentication checking part comprises:
a second remainder detecting part which divides the input refill identifier by a second devisor, detects a remainder obtained by dividing the input refill identifier by the second divisor, as a second reminder, and outputs the detecting result as a second detecting signal;
a second dialog window display instructing part which instructs to display a second input dialog window through which an authentication ID number corresponding to the detected second remainder is input, in response to the second detecting signal; and
an authentication ID number checking part which checks whether the authentication ID number input through the second input dialog window is authenticated, and outputs the checking result as a fifth checking signal to the remaining amount information-updating part and the error message display-instructing part.

28. The apparatus of claim 27, wherein the refill toner kit comprises an authentication card having authentication confirmation information including the second remainder and the authentication ID number corresponding to the second remainder.

29. The apparatus of claim 28, wherein the printer comprises a reference authentication card having reference authentication confirmation information corresponding to the authentication confirmation information of the authentication card.

30. The apparatus of claim 29, wherein the reference authentication confirmation information of the reference authentication card are stored in a memory of the printer.

31. The apparatus of claim 27, wherein the remaining amount information-updating controller comprises:
a repeating times checking part which checks whether an operation of the authentication checking part is repeated predetermined times and outputs the checking result as a sixth checking signal, in response to the first checking signal; and
a third calculating part which adds a random number to the second remainder and outputs the adding result as a third adding signal, in response to the sixth checking signal.

32. The apparatus of claim 22, wherein the remaining amount information-updating controller determines whether a characteristic representing the refill identifier of the refill toner kit is identical to one of reference values, to confirm the refill identifier of the refill toner kit.

33. The apparatus of claim 32, wherein the characteristic of the refill identifier comprises a calculation result corresponding to at least one of an addition of digits of a number representing the refill identifier, a summation of the number and a serial number representing the printer, a remainder and a divisor corresponding to the refill identifier, and the remainder and authentication confirmation number.

34. The apparatus of claim 22, wherein:
the refill toner kit comprises an authentication card having data corresponding to the refill identifier;
the printer comprises a reference authentication card having reference data; and
the remaining amount information-updating controller determines whether the data of the authentication card represents the reference data of the reference authentication card, to confirm the refill identifier of the refill toner kit.

35. The apparatus of claim 22, wherein the remaining amount information-updating controller displays a window when the update request is sensed, and receives data representing the refill identifier of the refill toner kit through the window so that the refill identifier of the refill toner kit is confirmed according to the data received through the window.

36. The apparatus of claim 22, wherein the remaining amount information-updating controller generates a message signal representing that at least one of the toner and the refill toner kit is not acuthenticated, when the refill identifier is not confirmed.
